(19) United States
(12) Patent Application Publication
(10) Pub. No.: US 2014/0091065 A1
(43) Pub. Date: Apr. 3, 2014

(54) PRODUCTION METHOD FOR RIFLE RECEIVERS

(71) Applicant: BROWNING INTERNATIONAL, SOCIETE ANONYME, (US)

(72) Inventors: Thierry DUMORTIER, Hermee (BE); Charles-Aurele GIELEN, Clavier (BE)

(73) Assignee: BROWNING INTERNATIONAL, SOCIETE ANONYME, Herstal (BE)

(21) Appl. No.: 13/848,467

(22) Filed: Mar. 21, 2013

(30) Foreign Application Priority Data
Mar. 22, 2012 (BE) 2012/0200

(51) Int. Cl. B23P 17/04; B23K 15/06; B23K 26/32; B23K 15/00

(52) U.S. Cl. CPC B23P 17/04; B23K 15/0006; B23K 15/06; B23K 26/3213
USPC 219/72; 29/428; 219/121.14; 219/121.64; 72/462

(57) ABSTRACT

Production method for a monobloc rifle receiver of aluminium or aluminium alloy, characterised in that this method consists of the realisation of individual parts of the receiver, which, in an assembled state can form a receiver; followed by any mechanical adjustments; followed by the assembly of these parts (8) by welding.

The invention concerns a production method for rifle receivers.

The role of the receiver is to support and keep all of the main components in place such as the barrel, the trigger guard, the stock, the magazine, the moving parts, etc. In addition to this role, the receiver has a dominant effect on the design and aesthetics of the weapon.

The receivers of firearms are mainly manufactured by machining a single block of a well defined alloy, primarily aluminium.

The receiver of a conventional rifle is made from a single 2 kg block of aluminium, for example, to give a finished part that weighs no more than around 300 g.

These parts are machined in a conventional workshop with a full set of machines such as multiaxis milling machines, reamers, grinding machines, etcetera.

An advantage of this production method by machining is that the mechanical characteristics of the aluminium alloy of the original block are preserved.

On the other hand a disadvantage is the production time and the costs of labour and the machines and tooling, especially when a receiver is a rather complex and precise part that must be manufactured within narrow tolerances.

This of course requires qualified people.

Another disadvantage is the loss of large quantities of raw material.

Another technique used is hot forging, which is a production technique that uses dies to form the heated non-ferrous alloy parts by plastic deformation. The machines used are hydraulic presses.

An advantage of this method is the homogeneity of the material and the nice surface finish.

A disadvantage resides in the moderate precision of the forged part.

Another known technique is lost-wax casting, also known by the name of FMP.

This casting process uses a wax model covered by heat-resistant ceramic, which, after removal of the wax by heat, becomes a mould for the part to be made.

The alloy is poured into the ceramic mould to then be destroyed by vibrating to recover the final part.

This method is characterised by the high precision of the parts coming out of the mould and a very fine surface finish.

However, this method is unsuitable for manufacturing parts with a complex geometry.

The purpose of the invention is to avoid the above-mentioned disadvantages and to provide a rapid and effective method for making receivers for high-quality rifles.

This objective is achieved according to the invention by providing a production method that consists of the realisation of individual parts of the receiver, which, in an assembled state can form a receiver; followed by any mechanical adjustments; followed by the assembly of these parts by welding.

The production method according to the invention provides a theoretical reduction of the production costs of close to 50% compared to the conventional machining processes currently used.

In addition, with the production now being done on the basis of two parts, any mechanical adjustments before final assembly are done more easily and more quickly, with the machines being able to work on a flat surface and over a larger area while requiring fewer tools and less complex machines, and less expertise on the part of the machine operators who do the machining operations on the inside surfaces of the finished receiver, as these surfaces are now more easily accessible.

The individual parts of the receiver are preferably manufactured by a semi-solid casting method.

The semi-solid casting technology provides protection against fluctuations in the price of converted aluminium, as this technology enables conventional casting aluminium to be used to manufacture the receivers, which makes the production more independent of the prices of the top quality machining aluminium currently used.

The semi-solid casting technique provides quasi-finished well made parts with good mechanical strength, density and finish, and only uses very little additional material compared to the conventional casting and machining processes, where the surplus materials are not reinjected into the production process.

In summary the method according to the invention drastically reduces the production costs of receivers.

Among the semi-solid casting methods, the method known by the name of “rheocasting” is preferred.

This is a casting process that utilises the thixotropic property of the semi-solid aluminium melt, which stipulates that the viscosity of the melt diminishes under the effects of agitation, primarily a shear stress.

To reach the semi-solid state, the melt must present liquid and solid phases, with this last-mentioned having to be characterised by a globular form. With rheocasting, the globular solid phase is obtained from a liquid metal cooled in a controlled manner to the optimum semi-solid state phase temperature by adding a billet of solid material equivalent to a certain percentage of solid fraction. This mixture is then made sufficiently liquid by agitation in order to enable it to be injected into a mould under pressure.

Preferably the receivers are assembled from two parts, preferably a half receiver or left side and a half receiver or right side.

The receiver parts are preferably assembled by welding only, in particular without extra connection elements, like pins which are mounted in through holes in the receiver parts and which can constitute a local weakening of the receiver, necessitating an enlarged thickness of the receiver or the application of reinforcing ribs.

The receiver parts according to the invention are preferably deprived of such reinforcing ribs and can thus present a predominantly smooth appearance at the outside, i.e. on the surface which is meant to be the external surface of the receiver.

The receiver parts are preferably assembled by electron beam welding.

Electron beam welding enables components to be welded due to the energy of the electrons bombarding the surface of the parts to be welded.

The electrons are extracted from a cathode, are then accelerated by an electrical potential and focused by magnetic coils. It is their kinetic energy, which converted into heat, creates the weld. In order to do this, the work must be done in a vacuum so as to better manage the emission of the electrons.

This assembly process enables high penetration of the weld, low deformations and contractions of the material through its highly localised application, as well as high welding speeds.

Although electron beam welding is the assembly method of choice, tests have shown that several welding processes are suitable within the scope of the invention, such as laser welding and friction stir welding.

The invention also concerns a mould that enables a part of a monobloc receiver for a rifle to be made according to the method of the invention.

For greater clarity, an example embodiment of a rifle receiver according to the invention is described hereinafter by way of an example, without any limiting nature, with reference to the accompanying drawings, wherein:

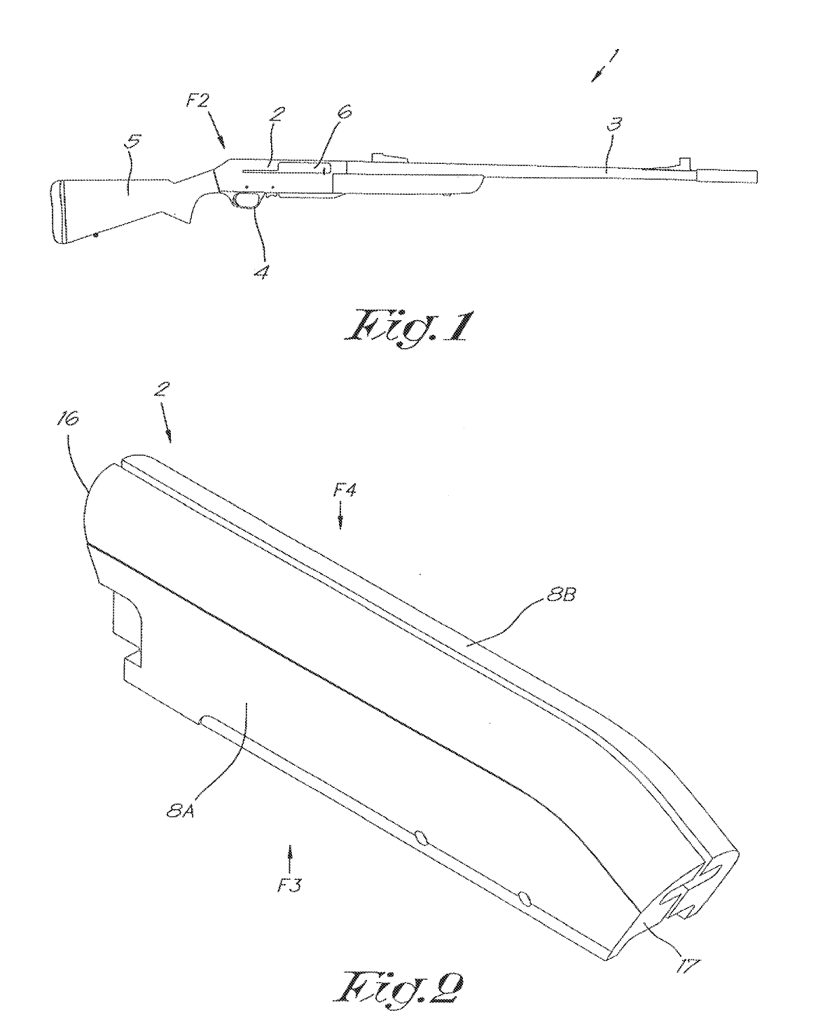

FIG. 1 is a schematic side view of a rifle equipped with a receiver according to the invention;

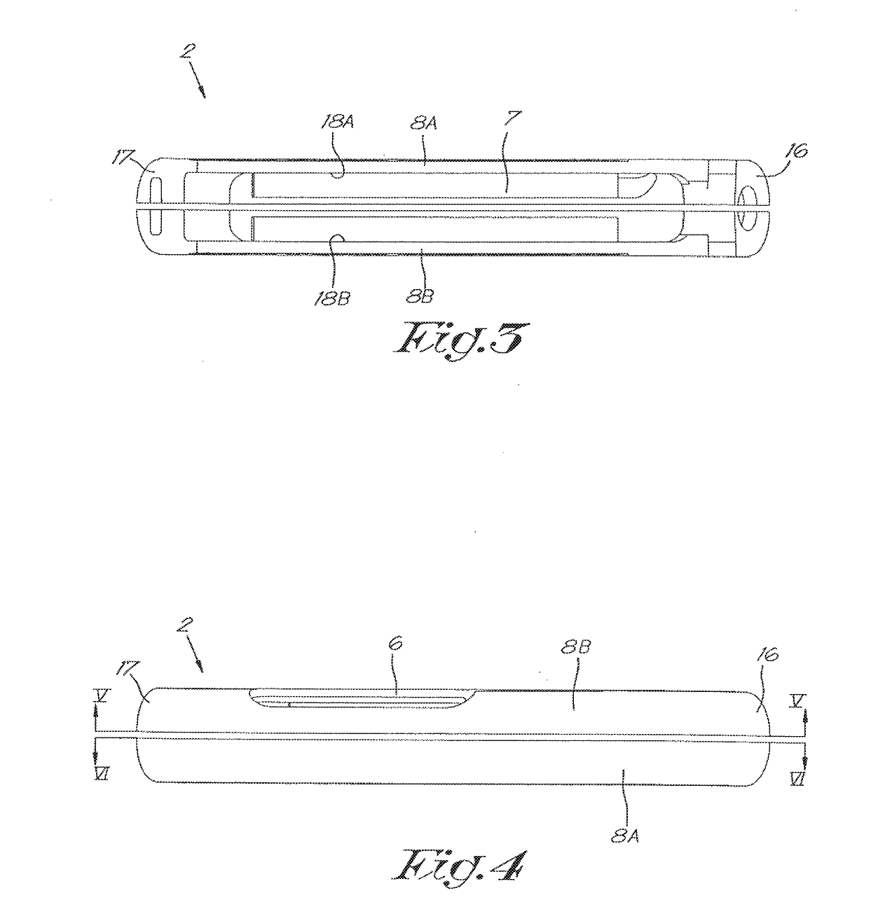

FIG. 2 shows the parts of the rifle receiver of FIG. 1 on a larger scale before assembly;

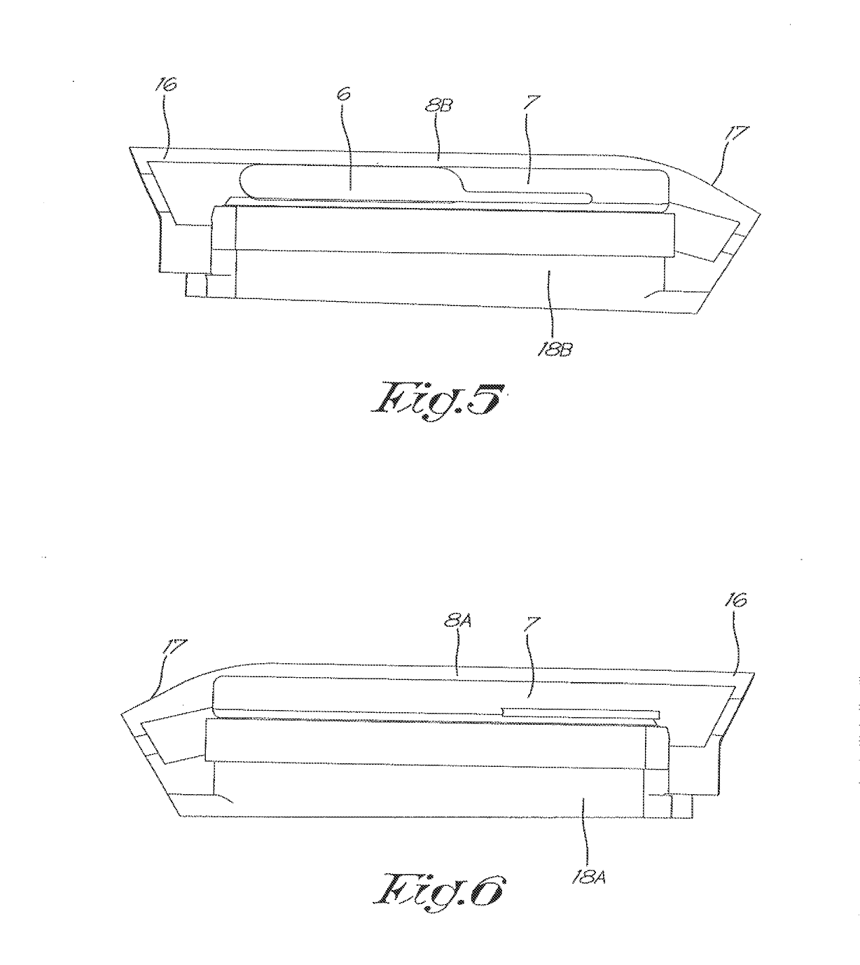

FIGS. 3 and 4 respectively show a view according to arrows F3 and F4 of FIG. 2;

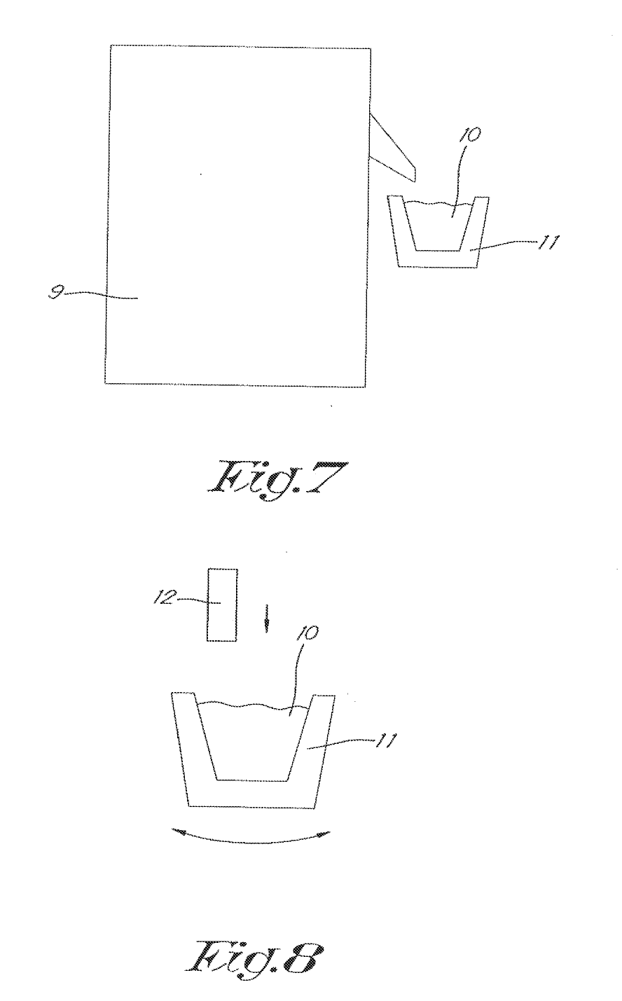

FIGS. 5 and 6 show views according to lines V-V and VI-VI of FIG. 4;

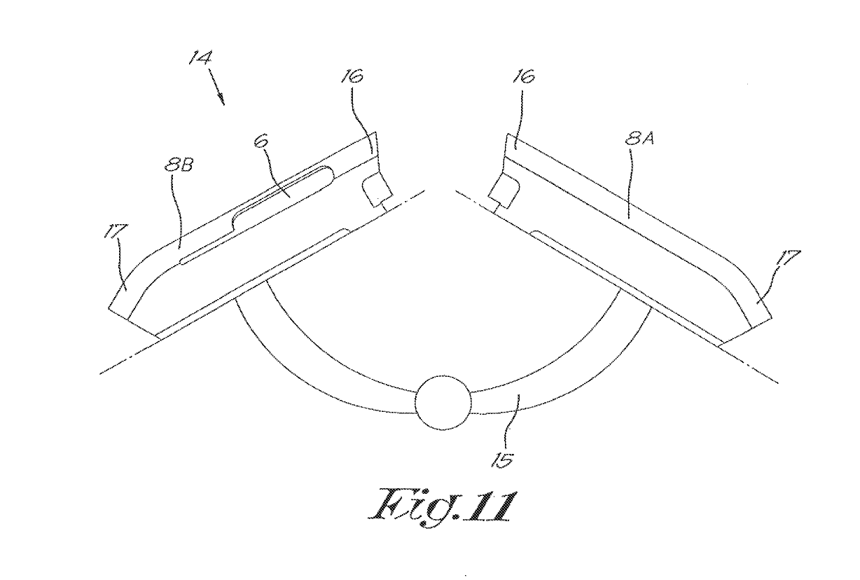

FIGS. 7 to 11 are a highly schematic illustration of the different stages of the production method according to the invention.

The semi-automatic rifle 1 shown in FIG. 1 comprises a receiver 2 that supports and keeps all of the main components of the rifle 1 in place, such as the barrel 3, the trigger guard 4, the stock 5 and the moving parts 6 that are only partially shown in the drawing, as they are essentially housed in a cavity 7 of the receiver 2.

This receiver 2 must be manufactured with high precision to avoid undesirable gap between the receiver 2 and the main components, and to enable guidance of the moving parts 6 without play in the receiver 2.

According to an embodiment of the invention, the receiver 2 is manufactured from several parts 8, of which there are two in the example of FIG. 2, i.e. a left side 8A and a right side 8B which, after assembly, form the unfinished structure of a complete receiver.

The two sides 8A and 8B are not generally symmetrical.

According to the invention, the two parts 8A and 8B are manufactured from aluminium or an aluminium alloy by a semi-solid casting method, preferably by the method known by the name of “rheocasting”.

The various descriptive steps of this method are schematically shown in FIGS. 7 to 11.

FIG. 7 shows a furnace 9 used to make a melt 10 of aluminium at the optimum temperature for the semi-solid state.

An appropriate quantity of the melt 10 is collected in a crucible 11, as shown in FIG. 7.

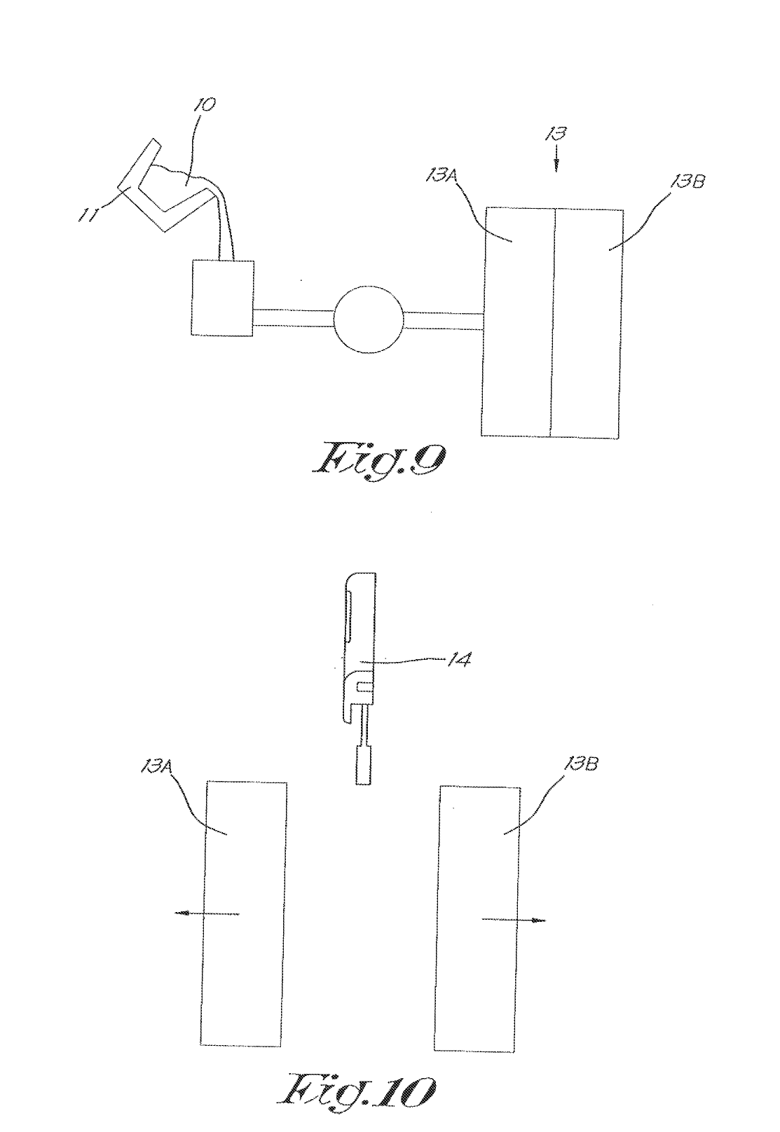

A billet 12 of solid material equivalent to a certain percentage solid fraction is then added, as shown in FIG. 8, in order to obtain a semi-solid melt which presents the liquid and solid phases, with the solid phase being characterised by a globular form.

This semi-solid melt has the property of being thixotropic, characterised by a high viscosity when the melt is immobile and by a viscosity that diminishes under the effect of a shear stress or under the effect of agitation.

While adding the billet, the crucible 11 is agitated vigorously by rotation in order to fluidize the melt.

This melt is then injected under pressure into a mould 13 formed by two shells 13A and 13B that define a cavity with the negative form of one or more parts 8 to be made.

The shells 13A and 13B of the mould 13 are then separated to recover the moulded part 14 from the mould.

A side view of this part is shown in FIG. 11 and in the example of FIG. 11 comprises the two parts 8A and 8B, which are linked by a sprue.

The two unfinished parts are then separated from the sprue 15 to obtain the two individual parts 8A and 8B, which are then machined lightly in certain places, such as the front part for example where the barrel is fixed, and the rear part which is designed to receive the stock.

In this stage of production the machining of the inside surfaces 18 of the receiver 2 is facilitated by the fact that these surfaces are easily accessible in the unassembled state of the parts 8A and 8B of the receiver 2.

The parts 8A and 8B are finally assembled by welding to form a receiver 2.

The assembly is preferably done by electron beam welding in a vacuum, or alternatively by laser welding or by friction stir welding.

It is clear that the invention is by no means limited to the examples described above, and that many modifications may be made to the method described above without departing from the scope of the invention as defined in the following claims.

1. A production method for a monobloc rifle receiver of aluminium or aluminium alloy, wherein the method includes the realisation of individual parts (8) of the receiver, which, in an assembled state can form a receiver (2); possibly followed by any mechanical adjustments; followed by the assembly of these parts (8) by welding.

2. Production method according to claim 1, wherein the receiver is assembled from two parts (8A and 8B), preferably a left half-receiver and a right half-receiver.

3. Production method according to claim 1, wherein the individual parts (8) of the receiver (2) are manufactured by a semi-solid casting method.

4. Production method according to claim 3, wherein the semi-solid casting method to make the receiver parts (8) is the method called “rheocasting”.

5. Production method according to claim 1, wherein the individual parts (8) of the receiver (2) are manufactured by hot forging.

6. Production method according to claim 1, wherein the individual parts (8) of the receiver (2) are manufactured by injection.

7. Production method according to claim 1, wherein the receiver parts (8) are deprived of reinforcing ribs.

8. Production method according to claim 7, wherein the receiver parts (8) have a predominantly smooth appearance at the outside, i.e. on the surface which is meant to be the external surface of the receiver.

9. Production method according to claim 1, wherein the receiver parts (8) are assembled by electron beam welding.

10. Production method according to claim 9, wherein the assembly by electron beam welding is done in a vacuum.

11. Production method according to claim 1, wherein the receiver parts (8) are assembled by laser welding.

12. Production method according to claim 1, wherein the receiver parts (8) are assembled by friction stir welding.

13. Production method according to claim 1, wherein the receiver parts (8) are assembled by welding only.

14. Mould for making a part in aluminium or aluminium alloy, wherein it enables a part (8) of a monobloc rifle receiver (2) to be made.
